(19) United States
(12) Patent Application Publication
(10) Pub. No.: US 2005/0167150 A1
(43) Pub. Date: Aug. 4, 2005

(54) Three-conductor cable

(76) Inventor: Christoph Studer, Gretzenbach (CH)

Correspondence Address: WENDEROTH, LIND & PONACK, L.L.P., 2033 K STREET N. W., SUITE 800, WASHINGTON, DC, 20006-1021, US

(21) Appl. No.: 10/509,393

(22) PCT Filed: Apr. 2, 2003
(86) PCT No.: PCT/CH03/00211

(30) Foreign Application Priority Data
Apr. 3, 2002 (CH) 551/02

(51) Int. Cl. H01B 7/00

(52) U.S. Cl. 174/113 R

(57) ABSTRACT

The invention relates to a three-conductor cable (10) consisting of three stranded electric cables (1), each comprising a core that has a current conductor (2) and a neutral and/or return conductor. Each individual cable (1) is essentially characterised in that the neutral and/or return conductor is configured from a number of individual conductors (4), distributed concentrically around the current conductor (2), that an insulating sheath (3) is provided between the current conductor (2) and the distributed individual conductors (4) of the neutral and/or return conductor and that a protective jacket covers the neutral and/or return conductor.

### TECHNICAL DOMAIN

The invention concerns a three-conductor cable for power transmission at a frequency of at least 50 Hz, preferably at least 100 Hz, for example 400 Hz.

In the 400 Hz range, what are referred to as high-frequency power transmission cables are used. They are required for example on aircraft and suchlike, in order to connect them during stationary periods to a fixed network or a mobile power supply. Because the aircraft's on-board electronics are highly sensitive to current fluctuations, the cable must not generate any damaging asymmetrical voltage drops.

Another domain of application is engine technology. Thus, for example, high-frequency power transmission cables can also be used to power motors for spindle drives (induction/synchronous motors) or brushless DC motors.

### STATE OF THE ART

Known high-frequency cables for frequencies of 400 Hz and above consist of four intertwined component conductors, consisting of three phase conductors and a neutral and/or return line. In this construction, two phase conductors lie adjacent to the neutral and/or return line respectively. Between these two in turn lies the third phase conductor. This asymmetry results in a detrimental inductive voltage drop, which takes on great significance especially in cables which are used at the higher frequency range.

Asymmetrical electrical fields also arise due to the geometry of this known four-conductor cable, which can propagate interference to the immediate environment. The geometry of four stranded single-conductor cables also means that the mechanical position of the arrangement is not clearly defined, and this must normally be resolved by a central element.

However, there are also high-frequency power transmission cables with a symmetrical cable arrangement. These cables do not have the geometry-induced disadvantages of the aforementioned four-conductor cable. In these, the phase conductors run in pairs, stranded about the centrally-disposed neutral and/or return line. This creates a symmetrical arrangement with the neutral and/or return line in the centre and six phase conductors stranded symmetrically about this. In this arrangement, two opposing phase conductors are connected with each other. In this construction the return line takes up half the cross-section of the phase conductor. This is a disadvantage when there is an asymmetrical load, as often occurs with wide-body aircraft. Although in operational status the construction has relatively low inductance, it is expensive and usually fairly inflexible. It also requires insulation of two parallel three-phase systems, which means additional expense for high-quality insulation material. Moreover, with this cable the two associated phase conductors must be combined before or inside the plug.

This second type of high-frequency power transmission cable thus demonstrates the disadvantage of a complicated and relatively expensive manufacture. Furthermore these cables have a smaller surface over which the heat losses building up internally can be dissipated into the environment.

### SUMMARY OF THE INVENTION

The invention is thus based on the problem of creating an electrical cable for power transmission at a frequency of at least 50 Hz and in particular a high-frequency power transmission cable which does not display the aforementioned disadvantages, whereby the latter especially should combine the advantages of a symmetrical arrangement with the flexibility and simplicity of twisted single-conductor construction and, with the same load capacity and operational safety, has a similar diameter to known four-conductor high-frequency cables.

This problem is solved according to the invention by a three-conductor cable with the characteristics of claim 1.

The three-conductor cable according to the invention is intended, for example, for power transmission in the higher frequency range, from 400 Hz upwards, and has a symmetrical construction of three intertwined electrical cables. Each of the three electrical cables is essentially characterised in that it consists of a phase conductor, an insulation, and a concentrically-running neutral and/or return line. Embedded in the concentrically-running neutral and/or return line are dummy and control conductors, whereby an external protective sheath is additionally applied on top of these and the neutral and/or return line.

The three-conductor cable thus contains one concentric, external neutral and/or return line per phase conductor, which, however, in completely symmetrical operation practically never has to be used. Only a small inductance results from the geometrical structure, and this has a positive effect on the voltage drop.

Advantageous embodiments of the invention will be apparent from the dependent claims.

### BRIEF DESCRIPTION OF THE DRAWING

Next, an embodiment of the invention will be described with the aid of the drawing, which shows:

FIG. 1: a perspective view of an electrical cable and

FIG. 2: a cross-section through a three-conductor cable according to the invention with three intertwined electrical cables in accordance with FIG. 1.

### DESCRIPTION OF A PREFERRED EMBODIMENT

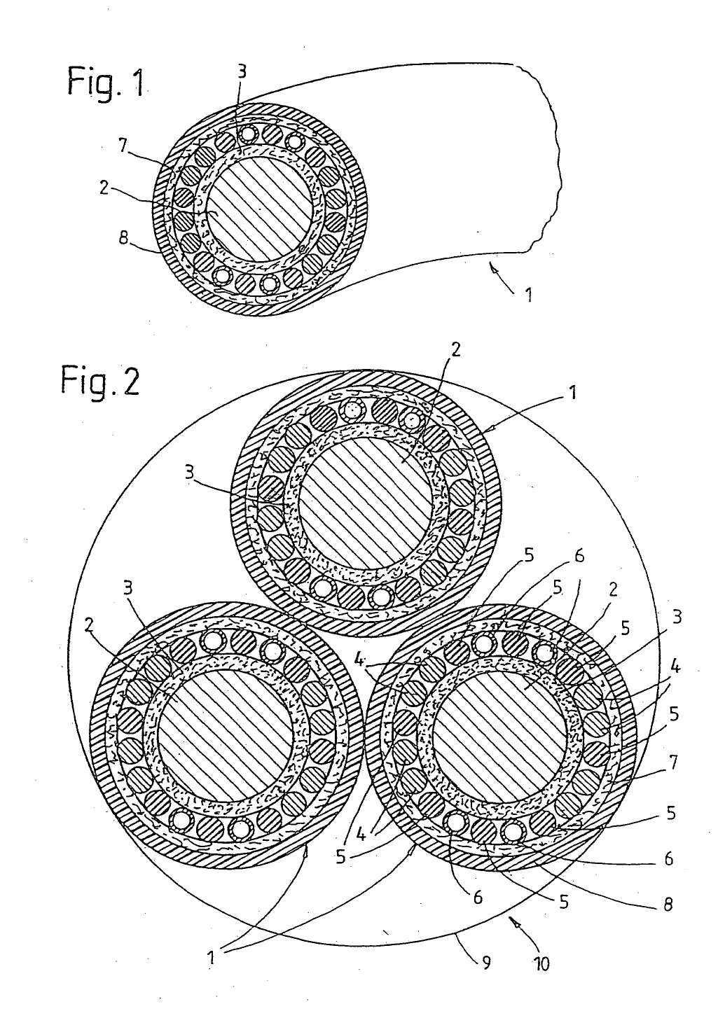

The electrical cable shown in FIG. 1 separately and in FIG. 2 intertwined with identical cables and referred to as a whole by the number 1 has a conductor conductor, namely an inner conductor 2 with several intertwined wires.

The inner conductor 2 is encased by a protective sheath 3, preferably made of plastic, hereinafter also referred to as insulation.

Embedded in the concentrically-running neutral and/or return line, formed for example by eight component conductors 4, are dummy conductors 5 and control conductors 6 which for their part are coupled for control, monitoring, measurement and command purposes.

Over the component conductors 4 of the neutral and/or return line, the dummy conductors 5 and the control conductors 6 is applied a fleece band 7 and over that a protective sheath 8 preferably made from plastic.

The following details which relate to the diameter of the various layers are given by way of example and relate to an electrical cable which has an inner conductor cross-section of approx. 50 mm² and is intended for power transmission at a frequency of 400 Hz. Obviously with a larger current conductor cross-section or different frequency ranges, the various cross-sections can increase or decrease accordingly.

The protective sheath 3 surrounding the inner conductor 2 is some 0.2 to 1.4 mm thick and consists for example of a plastic band, for example made of polyester, which winds about the inner conductor 2 with an overlap of for example 20 to 30% of the band width, and also an extruded plastic layer.

Disposed around the insulation 3 are the neutral and/or return line, the control conductors 6 and the dummy conductors 5, symmetrically stranded. The eight component conductors 4 forming the return line consist for preference of Cu wires with a cross-section of some 2.5 mm² each.

The fleece band 7 is wound around the stranding consisting of the component conductors 4, the neutral and/or return line, the control conductors 6 and the dummy conductors 5, with an overlap of for example 20 to 30% of the band width, whereby this preferably has a wall thickness of some 0.05 to 0.2 mm.

The sheath 8 encasing the fleece band 7 consists of known material and has a wall thickness of for example 1.5 to 5 mm.

The three-conductor cable shown in FIG. 2 and referred to as a whole as 10 has three intertwined electrical cables 1 of the aforementioned type. The three electrical cables 1 which are intertwined with each other can, in a special embodiment of the invention, however, additionally be held together by a sheath encasing them, for example in the form of a bandage or tube, which secures the electrical cables 1 against any axial displacement.

The three-conductor cable according to the invention has the advantages over the high-frequency cables described at the beginning that with the same load capacity, it has an absolutely symmetrical voltage drop on all three conductors, which proves smaller than in ordinary cables. At the same time a smaller mechanical bending moment is achieved due to the construction according to the invention and thanks to the simple structure, the connection layout in the connection plug is simple to realise. Furthermore, no central dummy conductor in addition to the defined stranding is necessary, so that the cable thereby becomes lighter and more flexible.

Moreover, as the result of the construction according to the invention, personal safety is increased. Before the phase conductor can be touched by being damaged with a metallic object, namely the neutral conductor carrying the earth potential must be damaged. The result of this is that in case of damage, the phase with the earth potential is short-circuited, before it can be touched live.

Compared with known four-conductor cables, the three-conductor cable has additional advantages such as a clear separation of control conductors and phase conductors, improved EMC behaviour and more stable distribution. Compared with known cables with symmetrical cable arrangement the three-conductor cable according to the invention has the further advantage of improved heat radiation.

The three-conductor cable according to the invention can be used in the frequency range of 50 Hz and over. Its symmetrical construction with relatively large cross-section of the return line offers optimal conditions for connections of asymmetrical loads. The symmetrical construction also offers striking advantages for flexible connections between UPS devices and data processing equipment, radar stations, and transmission equipment, inverter-motor connections with higher EMC requirements, etc.

It should be pointed out here that the electrical cable described with the aid of FIG. 1 and also the three-conductor cable shown in FIG. 2 represent only a selection of a number of potential embodiments of the invention and can be modified in various respects.

Thus for example there is the option of embedding the control conductors, not in the neutral and/or return line but in the respective phase conductor, as is the case in fact in known high-frequency cables. Also, the symmetrically distributed component conductors 4, instead of being stranded, can be disposed in meandering form about the phase conductor and the protective sheath 3 could consist of just one extruded plastic layer.

1. Three-conductor cable comprising three intertwined electrical cables, each with one conductor which has a current lead (2) and a neutral and/or return line, wherein the neutral and/or return line of each electrical cable is formed by a number of component conductors (4) which are distributed concentrically about the current lead (2), between the current lead (2) and the distributed component conductors (4) of the neutral and/or return line there is an insulation (3) and there is also a protective sheath (7) applied on top of the neutral and/or return line.

2. Three-conductor cable according to claim 1, characterised in that the current lead (2) of each electrical cable is encased in an extruded plastic insulation.

3. Three-conductor cable according to claim 1, characterised in that embedded in each concentrically-arranged neutral and/or return line, formed for example by eight component conductors (4), are dummy conductors (5) and control conductors (6) which are coupled for control, monitoring, measurement and command purposes.

4. Three-conductor cable according to claim 1, characterised in that in each current lead (2), control conductors (6) are embedded which are coupled for control, monitoring, measurement and command purposes.

5. Three-conductor cable according to claim 1, characterised in that over each neutral and/or return line a fleece tape (7) and over this a protective sheath (8) preferably made from plastic is applied.

6. Three-conductor cable according to claim 1, characterised in that the three electrical cables (1) are held together by a sheath (9) which encases them.

7. High-frequency electrical cable for power transmission at a frequency of at least 50 MHz characterised by a three-conductor cable according to claim 1.

8. Three-conductor cable according to claim 2, characterised in that embedded in each concentrically-arranged neutral and/or return line, formed for example by eight component conductors (4), are dummy conductors (5) and control conductors (6) which are coupled for control, monitoring, measurement and command purposes.

9. Three-conductor cable according to claim 2, characterised in that in each current lead (2), control conductors (6) are embedded which are coupled for control, monitoring, measurement and command purposes.

10. Three-conductor cable according to claim 2, characterised in that over each neutral and/or return line a fleece tape (7) and over this a protective sheath (8) preferably made from plastic is applied.

11. Three-conductor cable according to claim 3, characterised in that over each neutral and/or return line a fleece tape (7) and over this a protective sheath (8) preferably made from plastic is applied.

12. Three-conductor cable according to claim 4, characterised in that over each neutral and/or return line a fleece tape (7) and over this a protective sheath (8) preferably made from plastic is applied.

13. Three-conductor cable according to claim 2, characterised in that the three electrical cables (1) are held together by a sheath (9) which encases them.

14. Three-conductor cable according to claim 3, characterised in that the three electrical cables (1) are held together by a sheath (9) which encases them.

15. Three-conductor cable according to claim 4, characterised in that the three electrical cables (1) are held together by a sheath (9) which encases them.

16. Three-conductor cable according to claim 5, characterised in that the three electrical cables (1) are held together by a sheath (9) which encases them.

17. High-frequency electrical cable for power transmission at a frequency of at least 50 MHz characterised by a three-conductor cable according to claim 2.

18. High-frequency electrical cable for power transmission at a frequency of at least 50 MHz characterised by a three-conductor cable according to claim 3.

19. High-frequency electrical cable for power transmission at a frequency of at least 50 MHz characterised by a three-conductor cable according to claim 4.

20. High-frequency electrical cable for power transmission at a frequency of at least 50 MHz characterised by a three-conductor cable according to claim 5.

21. High-frequency electrical cable for power transmission at a frequency of at least 50 MHz characterised by a three-conductor cable according to claim 6.
